(19) United States
(12) Patent Application Publication
(10) Pub. No.: US 2004/0135903 A1
(43) Pub. Date: Jul. 15, 2004

(54) In-stream lossless compression of digital image sensor data

(76) Inventors: Lane C. Brooks, Watertown, MA (US); Keith Glen Fife, Stanford, CA (US)

Correspondence Address: Matthew E. Connors, Gauthier & Connors LLP, Suite 3300, 225 Franklin Street, Boston, MA, 02110, US

(21) Appl. No.: 10/685,222

(22) Filed: Oct. 14, 2003

Related U.S. Application Data
(60) Provisional application No. 60/417,978, filed on Oct. 11, 2002.

(51) Int. Cl. H04N 5/262

(52) U.S. Cl. 348/231.99

(57) ABSTRACT

A method and system provide in-stream compression of bytes of digital image sensor data. A specified number of least significant bits of the byte of digital image sensor data is masked or dropped to reduce the amount of image data if a frame of image data. After masking, alternate bytes of digital image sensor data are subtracted to produce an entropy-reduced data model. The difference bytes of digital image sensor data are split into a predetermined number of channels, each channel having a bit width such that the sum of the bit widths of each channel equals a bit width of the byte of digital image sensor data. Each channel is operated upon by a distinct cumulative distribution function before being multiplexed. The multiplexed digital image sensor data is encoded by arithmetic compression encoding. The method and system also utilize a division-free method of arithmetic encoding to simplify the hardware requirements of encoding. Lastly, the method and system utilize a round-robin removal approach for adaptively fixing a number of elements in a histogram.

### PRIORITY INFORMATION

This application claims priority from U.S. Provisional Patent Application, Serial No. 60/417,978, filed on Oct. 11, 2002. The entire contents of U.S. Provisional Patent Application, Serial No. 60/417,978, are hereby incorporated by reference.

### FIELD OF THE PRESENT INVENTION

The present invention is directed to firmware and processing techniques that enable in-stream, i.e., on-the-fly, compression of digital image sensor data for storage and/or processing of that image data.

### BACKGROUND OF THE PRESENT INVENTION

Typically, it is desirable to store image sensor data acquired by an image sensor, e.g., a CMOS image sensor, for subsequent access to the data; e.g., for downloading the image data to a computer to store or manipulate the image data, to a network to store or transfer the image data, or to a printer to print-out the image data.

FIG. 1 illustrates a basic conventional block diagram of an digital image recording system, such as a digital camera, in which an image signal recording system 1 includes a lens 2, an image sensor 3, a camera signal processing circuit 4, an image signal compression circuit 5, a recording mode selector circuit 6, a card identifying circuit 7, a system controller 8, a monitor screen 9, a card socket 10, a PC card 11, and a reference information storage circuit 12.

An image converged through the lens 2 is formed on the image sensor 3, which convert the image into an electrical image signal. After being processed through the camera signal processing circuit 4 including such known circuits as a white balance circuit, etc., the image signal is compressed as still picture data by the compression circuit 5. Then, through the socket 10, the compressed still picture data is stored onto the PC card 11. An image being recorded is displayed on the monitor screen 9 so that an operator of the image signal recording 1 can monitor the image.

As can be seen from the illustration, FIG. 1 is a medium to high-end camera implementation where JPEG or other processes such as auto exposure and white balancing are done on the camera. Thus, FIG. 1 does not reflect typical low-end cameras that do not perform JPEG or other processes such as auto exposure and white balancing on the camera.

Typical or conventional low-end cameras simply capture the raw image in a RAM and then transfer it to a non-volatile memory, such as a FLASH Memory for image data storage. When a user acquires an image with an image sensor; e.g., by pressing the shutter button of the digital camera; the image frame acquired by the image sensor must be transferred from the image sensor to the image data storage memory within the time allotted for a single image frame, which is defined by the frame rate of the sensor. This is because in general, an image sensor cannot store acquired image data for longer than a single frame.

For some image sensor applications, the characteristics of a FLASH memory can be sub-optimal for initial storage of image sensor data. More specifically, for many digital image applications, it has been found that FLASH memory cannot accept data at a speed compatible with typical image sensor frame times. In other words, FLASH memory is often not fast enough to accept a complete image frame within a specified image frame period.

For digital still camera applications, image compression is desirable for increasing the number of images stored in non-volatile memory and for reducing the time required to download images from camera to host. A frame buffer is usually required in cameras because non-volatile memory-write speeds are lower than the desired data rate of image sensors. Typically, image compression is performed after the transfer from sensor to frame buffer since the buffer is readily accessible for performing complex image compression techniques. However, typical compression techniques, such as JPEG, are not always appropriate.

Therefore, it is desirable to provide a system or method that enables FLASH memory to be optimal for initial storage of image sensor data. Moreover, it is desirable to provide a system or method that enables FLASH memory to accept data at a speed compatible with typical image sensor frame times. Furthermore, it is desirable to provide a system or method that enables FLASH memory to be fast enough to accept a complete image frame within a specified image frame period. It is further desirable to provide a system or method that positions the compression between the sensor and the frame buffer so as to reduce the size and cost of the frame buffer.

### SUMMARY OF THE PRESENT INVENTION

A first aspect of the present invention is a method for in-stream compression of bytes of digital image sensor data. The method captures a scene and converts the captured scene into bytes of digital image sensor data; compresses the bytes of digital image sensor data; stores the compressed bytes of digital image sensor data in a temporary memory; and transfers the bytes of digital image sensor data from the temporary memory to a permanent memory.

A second aspect of the present invention is a method of modeling, in stream, bytes of digital image sensor data for compression. The method masks a specified number of least significant bits of a byte of digital image sensor data and subtracts alternate bytes of digital image sensor data to produce an entropy-reduced data model.

A third aspect of the present invention is a method of encoding, in stream, bytes of digital image sensor data for compression. The method splits a byte of digital image sensor data into a predetermined number of channels, each channel having a bit width such that the sum of the bit widths of each channel equals a bit width of the byte of digital image sensor data; operates upon each channel of digital image sensor data with a distinct cumulative distribution function; multiplexes the distributed digital image sensor data; and encodes the multiplexed digital image sensor data using arithmetic compression encoding.

A fourth aspect of the present invention is a method of in-stream compression of bytes of digital image sensor data. The method masks a specified number of least significant bits of a byte of digital image sensor data; subtracts alternate bytes of digital image sensor data to produce an entropy-reduced data model; splits a difference byte of digital image sensor data into a predetermined number of channels, each channel having a bit width such that the sum of the bit widths of each channel equals a bit width of the byte of digital image sensor data; operates upon each channel of digital image sensor data with a distinct cumulative distribution function; multiplexes the distributed digital image sensor data; and encodes the multiplexed digital image sensor data using arithmetic compression encoding.

A fifth aspect of the present invention is a method of division free arithmetic encoding. The method fixes a number of elements in a histogram to a number that is a power of 2; determines a number of elements in a bin of a histogram; and performs a bit shifting operation upon the determined number of elements in a bin of a histogram to find a probability of a symbol to be encoded.

A sixth aspect of the present invention is a method for adaptively fixing a number of elements in a histogram. The method produces a new data element to be added to the histogram; adds the new data element to the histogram; tracks an order in which new data elements are added; and removes a data element from the histogram in accordance with the tracked order.

Another aspect of the present invention is a method for adaptively fixing a number of elements in a histogram. The method produces a new data element to be added to the histogram; adds the new data element to the histogram; increments a bin value, the bin value being number of elements in a bin, when a new data element is added to the histogram; determines if elements are to be removed from a present bin in the histogram; decreases a value representing a number of elements to be removed from the present bin in the histogram when it is determined that elements are to be removed from the present bin in the histogram; and removes an element from the histogram when the value representing a number of elements to be removed is decreased.

### BRIEF DESCRIPTION OF THE DRAWINGS

The present invention may take form in various components and arrangements of components, and in various steps and arrangements of steps. The drawings are only for purposes of illustrating a preferred embodiment and are not to be construed as limiting the present invention, wherein:

FIG. 1 is a block diagram showing a conventional digital camera system;

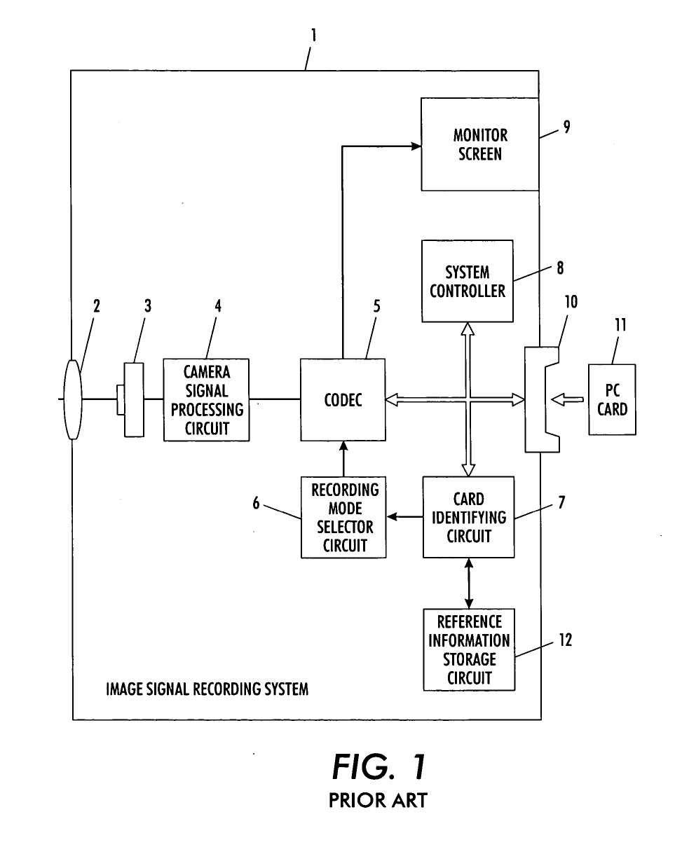

FIG. 2 is a block diagram showing a digital camera system according to the concepts of the present invention;

FIG. 3 illustrates an example correspondence between a system clock and SRAM timing requirements for data sent to the SRAM on a data bus;

FIG. 4 a flowchart showing an example control methodology that enables in-stream image data compression according to the concepts of the present invention;

FIG. 5 is a block diagram showing Bayer Differencing and bit dropping operations according to the concepts of the present invention;

FIG. 6 is a flowchart showing one perspective of a histogram storage and update technique according to the concepts of the present invention;

FIG. 7 is a diagram of the decompression operation according to the concepts of the present invention;

FIG. 8 illustrates a flowchart showing the weighted round-robin histogram update procedure for division-free arithmetic encoding according to the concepts of the present invention; and

FIG. 9 illustrates a block diagram of an encoder according to the concepts of the present invention.

### DETAILED DESCRIPTION OF THE PRESENT INVENTION

The present invention will be described in connection with preferred embodiments; however, it will be understood that there is no intent to limit the present invention to the embodiments described herein. On the contrary, the intent is to cover all alternatives, modifications, and equivalents as may be included within the spirit and scope of the present invention as defined by the appended claims.

For a general understanding of the present invention, reference is made to the drawings. In the drawings, like reference have been used throughout to designate identical or equivalent elements. It is also noted that the various drawings illustrating the present invention are not drawn to scale and that certain regions have been purposely drawn disproportionately so that the features and concepts of the present invention could be properly illustrated.

As noted above, digital still camera applications require image compression for increasing the number of images stored in non-volatile memory and for reducing the time required to download images from camera to host. To address this need, the present invention positions the compression between the sensor and the frame buffer. This allows the reduction in the size and cost of the frame buffer. In order to exploit this benefit, the present invention provides a hardware efficient compression engine that performs in-stream image compression.

The data stream from the image sensor contains raw Bayer data where pixels in each row alternate between either red and green or green and blue. With this color scheme, a data set that skips every other pixel is likely to show a stronger correlation than just a simple sequence of adjacent pixels. Since row buffers are not available during an in-stream compression scheme, all modeling must be limited to one dimension. Thus, the present invention provides a first-order predictive model that subtracts every other pixel and encodes the result.

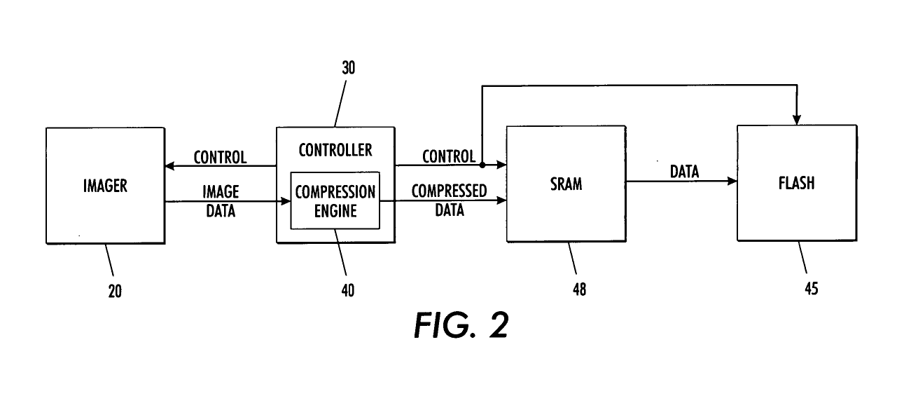

To realize the above, the present invention provides a circuit architecture that includes a SRAM. An example of such architecture is illustrated in FIG. 2.

FIG. 2 provides a block diagram of the components of an example imager system that enables capture and storage of a digital image, according to the concepts of the present invention. As illustrated in FIG. 2, the imager system includes an imager 20 that captures image scenes and converters the image into electrical signals or image data. A controller 30; e.g., an ASIC or other suitable hardware and/or firmware controller implementation; is included to provide data transfer management between the imager 20 and a memory unit. When the imager 20 is directed to capture an image, the controller 30 directs the imager 20 to transfer a frame of image data to a compression engine 40. The compression engine 40 can be implemented in Verilog, as a component of the controller 30. As the image data from the imager 20 is compressed, in-stream, the controller 30 directs the compressed image data to a SRAM 48 for temporary storage. Once a frame of compressed image data is fully stored in SRAM 48, the image data in the SRAM 48 is then directed to FLASH memory 45.

Note that in accordance with the present invention, the in-stream image data compression by the compression engine 40 must operate at the clock rate of the image data transfer from the imager 20. More specifically, there is not available a higher speed system clock that could provide the compression engine 40 with more processing time than corresponds to the image data transfer rate.

But for many applications, a particularly selected SRAM may not operate at the system clock rate, instead processing data at a rate that is, for example, three or more times slower than the system clock. As a result of this condition, for each compressed image data byte written to the SRAM 48, the compressor 40 has available to it three clock cycles of processing time. The compression engine 40 is then in effect operating as if it were controlled by a clock that is three times faster than the system clock governing the image data stream transfer. As explained in more detail below, this condition can be exploited to enable highly efficient data transfer between the controller 30, the imager 20, and SRAM 48.

In FIG. 2, the data busses are shown as separate busses between the imager 20 and controller 30, between the controller 30 and SRAM 48, and between the SRAM 48 and the FLASH memory 45. In accordance with the present invention, this is not required. Alternatively, a single data bus can be employed for transferring data between the various imager system components. In other words, the concepts of the present invention accommodate for configurations in which only one data bus is available and/or on which all data transfers between the various components must occur.

It is further noted that although the present invention, as described in detail below, utilizes a single-bus system implementation, such a single-bus system implementation is not required by the concepts of the present invention.

In accordance with the concepts of the present invention, the bandwidth or speed limitations of FLASH memory are compensated for by use of a temporary buffer 48 of FIG. 2; e.g., an SRAM; that accepts and stores an acquired frame of image data within a specified image acquisition frame time, for later routing to and/or more permanent storage of that data in a FLASH memory.

It has been found that for some applications, the use of an SRAM can pose a data storage problem if the SRAM data storage capability is not sufficient for a selected image sensor. For example, given a digital CMOS image sensor including 1.3 million pixels, with each pixel producing 8 bits of image data, and an SRAM having a 1 MB data storage capability, a full frame of image data cannot be held in the SRAM at any given time. Thus optimally, a temporary buffer is needed that is large enough to store the 1.3 million bytes of image data within a single image acquisition frame time, typically, e.g., ˜10 ms. The present invention provides a number of embodiments that can be employed to accommodate this data storage requirement.

In one embodiment, in accordance with the concepts of the present invention, both the FLASH 45 and the SRAM 48 can be employed to store the sensor image data during a single frame time. The data stream from the image sensor is split between the SRAM and the FLASH memory. Under this approach, the data rate of the stream to the SRAM and the FLASH memory sum to equal the data rate of the sensor. One would maximize the data rate to the FLASH memory to minimize the data rate to the SRAM and thus minimize the size and speed of the SRAM. For example, if a 1.3 MP image sensor is running at 10 fps, the data rate from the sensor is 13 MB/sec. If the maximum data rate of the flash memory were 5 MB/sec, the stream to the SRAM would need to be 8 MB/sec. At the completion of the image acquisition, 500 KB of data would be in the FLASH memory and 800 KB would be the SRAM. Then the 800 KB in SRAM can be transferred to the FLASH memory for permanent storage of the complete image.

In a second embodiment, in accordance with the concepts of the present invention, multiple SRAM buffers are used to accept the image sensor data. For example, the use of a 1 MB SRAM in conjunction with a 512 KB SRAM is sufficient for temporary storage of a full 1.3 million bytes of image data within a single image acquisition frame period.

In a third embodiment, in accordance with the concepts of the present invention, the image data is compressed in-stream, i.e., on-the-fly, as the image data is acquired from an image sensor during a single image acquisition frame period, and before the data is written to an SRAM. By employing a sufficiently high compression ratio, a SRAM having a storage capability that is less than that required for a selected image sensor can accommodate a full frame of image data.

For example, with a sufficiently high data compression ratio, image data produced by 1.3 million image sensor pixels can be accommodated by a 1 MB SRAM. Once stored in the SRAM, the compressed image data can then be sent from the SRAM to a FLASH memory at a subsequent time for more permanent storage. The data sent to the FLASH can be in compressed or decompressed form.

It is noted that for many applications, a compressed form is preferred. This FLASH storage of compressed data enables an increase in data storage by the FLASH. As a result, a smaller and/or less costly FLASH memory can be employed, and transfer of the compressed data from the FLASH memory for a subsequent application, e.g., transfer to a PC, can be faster and require a reduced data transfer capability.

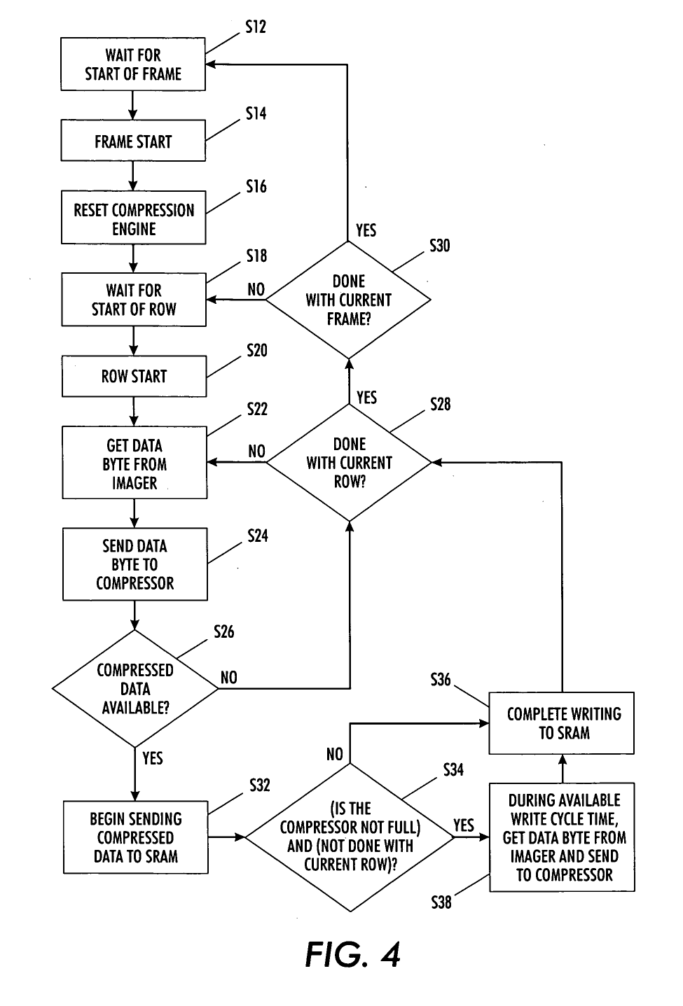

FIG. 4 provides a flowchart of an example, in accordance with the concepts of the present invention, of a control methodology that enables the in-stream image data compression alluded to above. In this illustrated example, the controller first waits, at step S12, for the start of a new image frame. When a new frame starts, the controller resets, at step S16, the compression engine. The controller then waits, at step S18, for the start of a new row of the current frame. When a new row starts, at step S20, the controller gets, at step S22, an image data byte from the imager and sends, at step S24, the data byte to the compression engine.

After sending one data byte to the compression engine, the controller checks if the compression engine has completed compression of any data, and therefore, if any compressed data is available, at step S26, for transfer to the SRAM. If there is no compressed data available, the controller then checks if the current row of image data has been processed, at step S28. If the current row has not been completely processed, then the controller gets, at step S22, another data byte from the imager for sending to the compressor. If the current row has been completely processed, then the controller checks if the current frame has been processed, at step S30. If the current frame has not been completely processed, then the controller waits for the start of another row of data from the imager, for sending that image data row to the controller. If the current frame has been completely processed, then the controller awaits the start of a new frame.

Returning to the controller's check to determine if compressed data is available, at step S26, from the compression engine, if there is compressed data available, then the controller begins sending, at step S32, that compressed data to the SRAM. Once directing of data to the SRAM is begun, the controller then checks, at step S34, if the compressor is not full of data being compressed, and if the compressor has not completed processing the entire current image data row. If the compressor is full of data to be compressed, then the controller completes, at step S36, the data writing to the SRAM, and then checks, at step S28, if compression processing of the current row is complete.

If the compressor is not full and has not completed compression processing of the current image data row, then during any write cycle time that is not required by the SRAM, if such is available, the controller gets, at step S38, a data byte from the imager and sends that data to the compression engine. The controller then completes, at step S36, the data byte writing to the SRAM in the current SRAM write cycle. This preferred embodiment of the present invention is utilized with an architecture or system in which a single data bus must be or is preferably employed for transfer between the controller and both the imager and the SRAM.

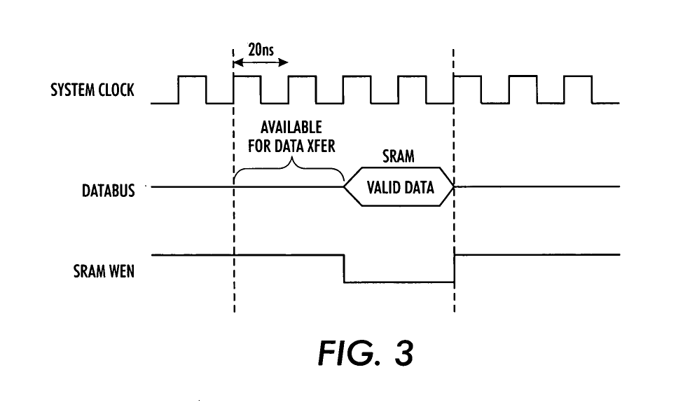

FIG. 3 illustrates an example correspondence between the system clock and SRAM timing requirements for data sent to the SRAM on a data bus. In this example, the system clock operates at a 20-nanosecond clock cycle. The SRAM, in this example, requires an 80-nanosecond write cycle; i.e., a new data byte can be accepted by the SRAM every 80 nanoseconds. Within the 80-nanosecond SRAM write cycle, data to be sent to the SRAM must be valid on the data bus for only a part of the write cycle, for example, for 40 nanoseconds, during which a write enable (SRAM WEN) signal is set.

This condition, in which the data needs be valid for only a portion of the SRAM write cycle, provides a portion of the SRAM write cycle during which the data bus can be employed for other purposes; e.g., for directing data from the imager to the compression engine. Therefore, in accordance with the present invention, any such available time during the SRAM write cycle is preferably employed to effectively multiplex imager data with compressed data on a single bus during the SRAM write cycle, thereby more effectively utilizing the bus and increasing the time available to the compression engine for processing image data to be sent to the SRAM. As a result, the compression engine is effectively operating at a clock rate that is faster than that of the SRAM. Thus, this technique eliminates a requirement for the image sensor frame rate to be slowed down to accommodate the data compression rate and/or the SRAM data storage rate.

Turning now to specific aspects of the data compression techniques provided by the present invention, data compression in general requires two tasks. The first is a modeling task, in which the data is modeled to describe any redundancy in the data, thereby to reduce the entropy of the data set. The second task is a coding task, in which the data is encoded to produce a compressed version of the data.

First considering the data modeling task, in general, images typically contain a great deal of redundancy that can be exploited to decrease the entropy of the image data. A data set can be losslessly compressed to only the entropy of the data itself; i.e., a high entropy data set can be compressed to a lesser extent than a data set of relatively lower entropy. In accordance with the present invention, any suitable data model can be employed; e.g., a predictive model such as that employed in CALIC (Context Adaptive Lossless Image Compression), or other selected models that enable a decrease in data entropy.

For many imager applications, however, a significant constraint on hardware is placed such that row buffers and associated hardware typically required for many modeling techniques cannot be employed. For example, row buffers are often required for modeling techniques in which a neighborhood of pixel data values is examined to predict the value of a center-neighborhood pixel under consideration. When hardware limitations of an imager system do not accommodate the use of such row buffers, this neighborhood modeling approach cannot be employed. When such is the case, it is preferred that hardware requirements be minimized in accordance with the imager system characteristics, and that a corresponding data model be employed; e.g., a first-order predictive modeling technique.

In an example of such a first-order modeling technique provided by the present invention, image data from the image sensor is provided as rows of raw Bayer data; i.e., each pixel in each row alternates between either red and green or green and blue. As a result, data from every other pixel in a row is more correlated than data from adjacent pixels.

Given this correlation, in the modeling technique it is assumed that the data values from two closest same-color pixels in a row of pixels are equal. If the two data values are not equal, the difference between the two values is encoded as an error. This technique, Bayer Differencing, is thus accomplished by subtracting the data value of a given pixel to be encoded from the data value of a pixel located two columns previous to the given pixel in the image sensor array of pixels.

Bayer Differencing can significantly decrease the entropy of an image data set. For example, when the original image data from two different images is entropy encoded, the image data can be compressed by 9% and by 28%, respectively. However, using a Bayer Differencing modeling approach, the same image data from the two different images can be compressed by 25% and 55%, respectively. Bayer Differencing can therefore be employed as a powerful technique for reducing entropy such that increased compression ratios are attainable.

But Bayer Differencing cannot guarantee a selected compression ratio. As explained above, this can be a concern for scenarios in which the storage capacity of an SRAM buffer memory is less than the capacity required to store an entire frame of image data.

The present invention provides a technique, “bit dropping,” that enables the use of Bayer Differencing while imposing a desired compression ratio. In the technique, according to the concepts of the present invention, when a frame of image data is acquired by the image sensor, compressed, and then directed to the SRAM memory buffer, it is determined if the full frame of compressed image data can indeed be stored on the SRAM. If the full frame of compressed image data does not fit in the SRAM, then when a second frame of image data is acquired, the controller processes the data such that the least significant bit (LSB) of each pixel data value is dropped before performing Bayer Differencing and compression operations are performed on the data.

On a white noise image, each dropped bit of image data is found to result in an increase of the compression ratio by about 12.5%. If it is found that even with the LSB of image data dropped, a full frame of compressed image data cannot be accommodated by the SRAM, upon acquisition of a next subsequent image frame, the controller specifies that two LSBs be dropped from each byte in the image data stream for that frame. In accordance with the present invention, LSB dropping can be continually repeated until it is found that a sufficiently high compression ratio is achieved to enable a full frame of image data being stored by the SRAM buffer.

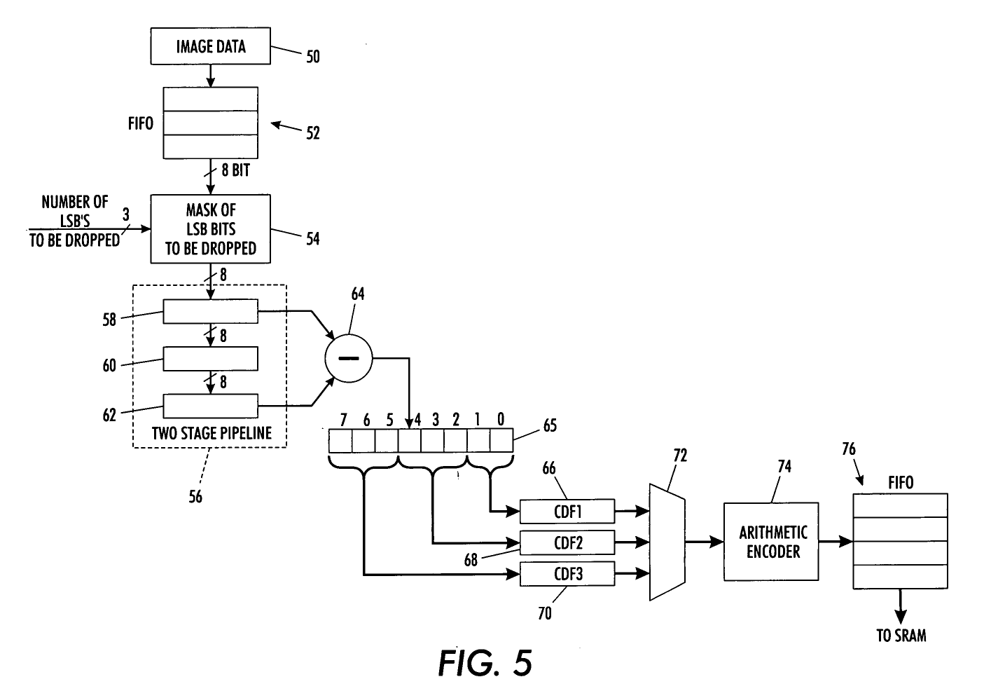

Referring to FIG. 5 there is shown a block diagram of the Bayer Differencing and bit dropping operations described above. The image data 50 acquired by the image sensor 20 (not shown) is first directed to a FIFO 52 in which three consecutive pixel data value bytes are held. The number of LSBs to be dropped, if any, from the image data bytes are specified by programmable firmware or other suitable technique to produce a corresponding mask 54 of LSBs to be dropped. This mask 54 can be imposed on the pixel data values by; e.g., a barrel shifter, or other selected technique.

With an imposition of dropped bits, the masked pixel data is then directed to; e.g., a two-stage or two-byte; pipeline 56 for carrying out the Bayer Differencing operation. As illustrated, three consecutive previous pixel values 58, 60, and 62 are saved such that alternate pixel bytes 58 and 62 can be subtracted by a subtractor 64 to produce an entropy-reduced data model to be encoded for data compression.

After modeling, the image data stream is encoded to produce a compressed stream of image data for storage at the SRAM buffer. There are numerous suitable methods for encoding the stream that can be employed in accordance with the present invention.

A first example encoding technique is the LZW technique, which is a dictionary-based run-length encoding technique. This technique is quite hardware intensive and thus may not be suitable for all applications. In addition, the LZW technique requires large adaptive lookup tables, and generally its performance improves as the number of tables is increased. It also requires matching against these lookup tables, an operation that can be difficult to carry out in a single clock cycle.

A second example encoding technique is Huffman encoding. Huffman also can be employed for many applications, but like the LZW technique is not very hardware efficient due to requirements for storing trees and for variable length encoded table look-up operations.

For many applications, it is found that arithmetic encoding can be a preferable compression technique. A compression code can be produced in a single clock cycle as the result of a calculation, and the encoding process can reach the entropy of the data set.

An adaptive implementation of arithmetic encoding is understood to enable achievement of high compression ratios. Specifically, it is found that arithmetic encoding can optimally be implemented by storing data values in a cumulative histogram; i.e., a running summation of a histogram.

Arithmetic encoding is employed by the present invention to encode the data stream because it does not require large hardware lookup tables or trees. The encoded symbol can be efficiently obtained in a single clock cycle as the result of a calculation. Furthermore, arithmetic encoding can reach the entropy of the data set regardless of the probability distribution. This enables the channel splitting technique described below.

The use of adaptive arithmetic encoding is essential for high compression performance; however, adaptive arithmetic encoding requires two hardware intensive operations. One is a division to calculate the probability from the adaptive histogram, and the other is a multiplication to rescale the state variables of the encoder. There are some techniques that facilitate multiplication-free arithmetic encoders in order to reduce the hardware requirements of that function.

For further reduction in hardware, a division-free adaptive histogram technique is utilized by the present invention. To explain division-free adaptive histogram technique in more detail the following example will be used.

Suppose a histogram of M bins has bin counts of m₁, m₂, . . . , m_{M}, and the total number of elements in the histogram is N=m₁+m₂+ . . . +m_{M}. When the arithmetic encoder seeks to encode a symbol, the probability of that symbol must be calculated as pₓ=mₓ/N.

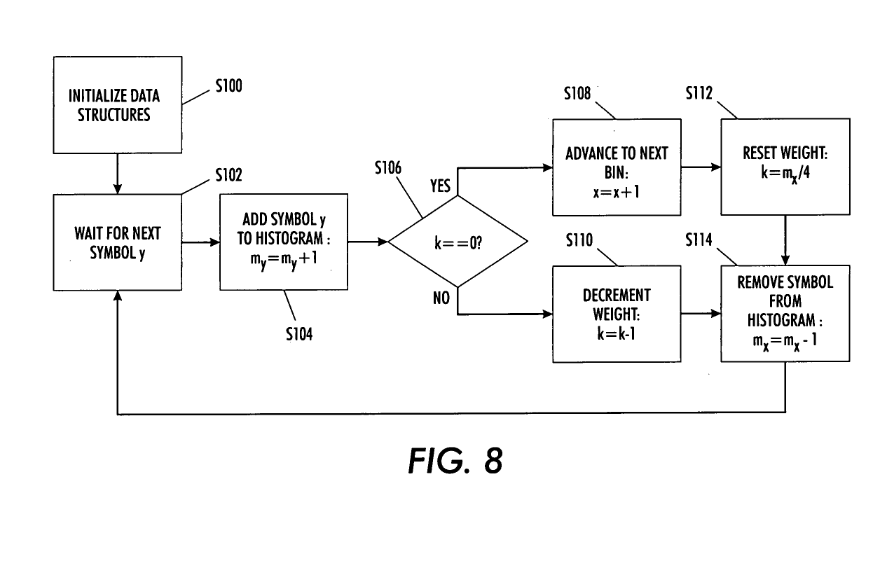

To remove the need for this division, the present invention uses an adaptive histogram technique that keeps N fixed at a power of two such that the division reduces to a simple bit shift. To keep N fixed, the present invention removes elements from the histogram as new elements arrive in a weighted round-robin fashion as shown in the flowchart of FIG. 8.

As shown in FIG. 8, the data structure is initialized at step S100, wherein the process sets k=0 and x=0, and the histogram bins are set to 0. At step S102, the present invention waits for the next symbol y. Upon receiving the next symbol y, the process, at step S104, adds symbol y to the histogram and increments m_{y} by one, wherein m_{y} is the number of elements in bin y. At step S106, the present invention determines if k=0, wherein k is the removal weight factor. When entering a bin for removal, k is the number of elements to be removed.

If step S106 determines if k=0, step S108 causes the process to advance to the next bin and to increment x by one wherein x represents the bin from which elements are being removed. This count will wrap to zero when x equals the number of bins in the histogram. At step S112, the present invention resets the removal weight factor to: k=(mₓ)/4.

If step S106 determines if k≠0, step S110 causes the process to decrement the removal weight factor to: k=k-1. At step S114, the symbol is removed from the histogram and mₓ is decremented by one wherein mₓ is the number of elements in bin x and mₓ must always be greater than zero. If mₓ is equal to one, neither the addition nor the removal of an element occurs.

A challenge is posed, however, by the requirement for storage of the histogram. In the case of 8-bit pixel image data, 256 bins are required. It has been found experimentally over a broad range of images that about 10 bits of data precision, corresponding to 1024 data bytes, are optimally employed in each data bin to reach a good trade-off between a scenario in which the size of a data window being encoded will get to such a large size that encoding statistics do not accurately portray a local area and a scenario in which the size of the data window will get to such a small size that insufficient data is available for producing meaningful statistics. In other words, a depth of 10 bits in each bin provides a good trade-off between letting the adaptive histogram go stale versus having enough data to yield good statistics.

This 10-bit requirement in turn requires 10×256=2560 bits worth of data storage registers. Such cannot be provided in an SRAM because all data bins need to be simultaneously accessible for updating, given that the compression operation is tied to the clock rate and thus no extra clocks cycles are available for each byte to be compressed.

As a result of this high hardware demand, compression encoding of 8-bit data values by an adaptive encoding histogram technique can be challenging for many applications. The present invention addresses this challenge by providing a technique in which a stream of 8-bit image data bytes is split into channels, with each separate channel processed as a distinct data stream. As explained in more detail below, this channel splitting technique is found to yield compression ratios that are similar to that achieved when employing a non-split data stream.

In a first embodiment of channel splitting technique, provided in accordance with the present invention, the 8-bit wide image data stream is split it into two 4-bit wide data streams. With this configuration, and employing arithmetic encoding, two histograms are employed during the encoding process to keep track of the encoding statistics for the LSB channel and for the MSB channel independently. This greatly reduces the hardware requirement from that for a single channel process, as this embodiment only requires two 16-bin histograms, and the precision of the histograms can be reduced to 9 bits. This results in a histogram register count requirement of 2×9×16=288 bits, which is nearly 10 times smaller than that required for a full 8 bit-wide image data stream.

The channel splitting technique of the present invention can be further extended in accordance with the present invention. For example, the 8-bit wide image data stream can be divided into three data streams; i.e., three distinct data channels. The split can take any suitable configuration; e.g., one 2-bit channel and two 3-bit channels as 3-2-3, or 2-3-3, moving from MSB to LSB.

This three-way channel splitting enables the histogram bin precision to be dropped to 8 bits while yielding compression results that are similar to that achieved with a full 8-bit wide image data channel. The hardware required for the three channel split histograms is (2×8×8)+(4×8)=160 registers, a significant drop in hardware requirement; i.e., a 16× reduction in the number of registers needed for the adaptive histogram. This image data channel splitting can be further extended, if appropriate for a given application, and given that adequate clock cycles are available for the number of channels to be employed.

Turning back to FIG. 5, there is shown an example configuration for the channel splitting technique of the present invention. Once a subtraction is carried out to complete the Bayer Differencing operation described above, the resulting 8-bit wide image data word is split into a number of channels by channel splitter 65, here shown by way of example as 3 channels, with the channels divided as 3-3-2 bits, going from MSB to LSB. The channel splitter 65 may be realized by a simple register. The three channels are piped to separate, distinct, corresponding histograms; i.e., three distinct cumulative distribution functions 66, 68, and 70. Data from the three distribution function histograms 66, 68, and 70 are multiplexed by multiplexer 72 and then encoded by a suitable arithmetic compression encoding implementation circuit 74 as described below. The resulting compressed image data, which can be of varying bit number from pixel data to pixel data, is then sent to a FIFO 76 and directed by the imager controller 30 to the SRAM 48 for temporary storage.

Turning now to histogram storage and update techniques provided by the present invention to be applied to each data channel's cumulative distribution function, it has been shown that the application of arithmetic encoding to such histograms can be carried out while eliminating the need for multiplication operations. The present invention enables this elimination of multiplication operations, and goes further to simplify the division operations necessary for the adaptive encoding technique where the total number of elements, N, in the histogram may be changing as the encoding progresses.

In accordance with the present invention, each division operation is simplified to a bit shift operation. This is achieved by imposing conditions in which the number of elements, N, in a given histogram is required to remain fixed and to be a power of 2. To enforce this last condition, for each data element added to a histogram, one must be taken away. This could be done using a FIFO approach where one tracks the order in which elements are added and they are removed in order. This, however, requires much more hardware than the technique developed for the present invention.

The present invention employs two pointers, namely, an addition pointer and a subtraction pointer, which each pointer points to a particular bin in a histogram. In general, when a new data element has been produced by the pipeline to be added to a histogram, the number of the bin to which the addition pointer is pointing is incremented and the bin to which the subtraction pointer is pointing is decremented.

It is noted that from a theoretical perspective, splitting the 8-bit data into three independent channels is similar to treating the original 8-bit stream as a geometric distribution of the three channels. This approximation, when combined with the division-free method of adaptive histogram, as discussed above, produces results comparable to no channel splitting at all. Since further channel splitting starts to degrade performance while the reduction in hardware is negligible, three channels was found to be preferable in conjunction with the concepts of the present invention.

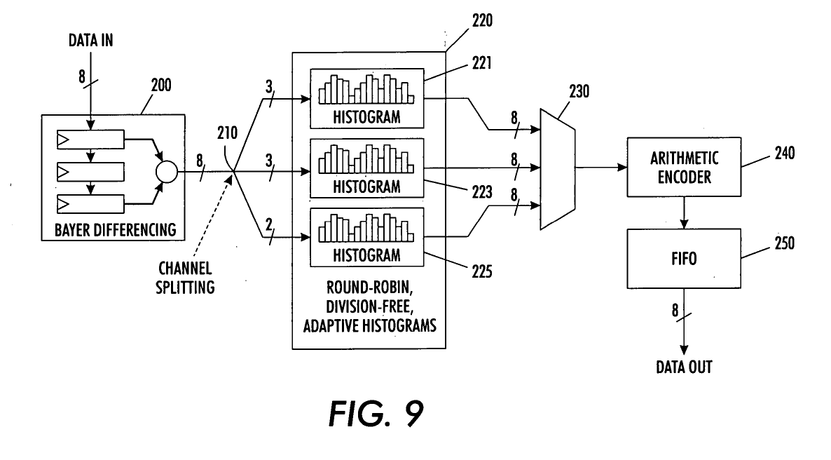

Combining the above techniques yields a hardware efficient method of lossless in-stream image compression. Over a wide class of images, the present invention yields an average of 46% compression ratios. FIG. 9 provides another perspective on the channel splitting concept wherein a complete compression engine with the addition of a small output FIFO to absorb jitter produced by the variable length encoding is illustrated.

As shown in FIG. 9, a Bayer Differencing module or circuit 200 that produces an 8-bit dataword receives data. The 8-bit dataword is then split into three channels by splitter or mask 210. In a preferred embodiment, as noted above, the dataword is split into two 3-bit datawords and a 2-bit dataword. The datawords are fed into a round-robin, division-free, adaptive histogram 220, as described above. The round-robin, division-free, adaptive histogram 220 includes three histograms 221, 223, and 225. Data from the three histograms 221, 223, and 225 are multiplexed by multiplexer 230 and then encoded by a suitable arithmetic compression encoding implementation circuit 240 as described below. The resulting compressed image data, which can be of varying bit number from pixel data to pixel data, is then sent to a FIFO 250.

The compression engine of FIG. 9 functions without the need for any peripheral devices, such as RAM or a processor, and the total number of registers in the complete design total is 269. Synthesized for a 0.35 μm process, the design takes 0.3 mm² of area and approximately 7000 gates.

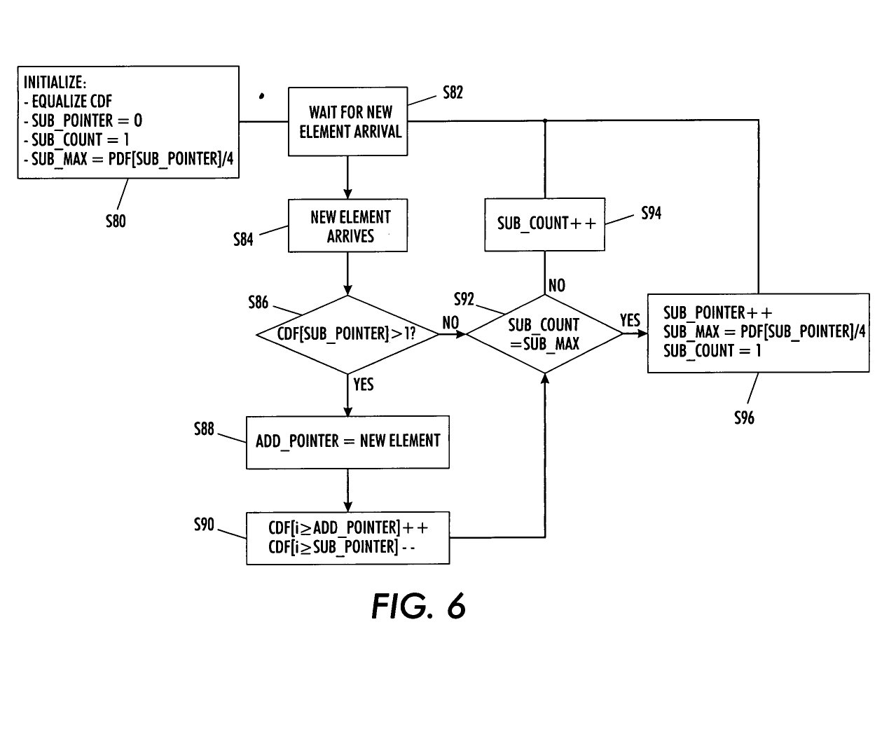

FIG. 6 provides another perspective on a histogram storage and update technique according to the concepts of the present invention. More specifically, FIG. 6 provides a flowchart of another perspective on an implementation provided by the present invention for enabling lossless in-stream image compression.

As illustrated in FIG. 6, the system is initialized, at step S80, by setting the histogram; i.e., cumulative distribution function, to a known value, with an equal number of elements in each histogram bin. This is important because both the compression engine encoder and the corresponding decoder, described below, must be guaranteed to begin processing at a common point in an image data stream to ensure correct correspondence between the compressed and subsequently decompressed data. The subtraction pointer, sub_pointer is set to point to bin 0. The subtraction count, sub_count, which represents how many data elements have been subtracted out of a given bin, is reset to 1, and the total number of data elements that will be subtracted out of the subtraction pointer bin is set to the value of the bin divided by a selected factor, here for example, 4. This division factor is selected based on a condition in which the proportional ratio of elements between bins of the histogram is to remain constant. To achieve this condition, the subtraction pointer is held in a given bin a number of encoding cycles that corresponds to the number of bin elements, divided by some proportional factor, e.g., 4.

With cumulative distribution function initialization complete, the system waits, at step S82, for the arrival from the channel splitting pipe of a new data element. When a new data element arrives, at step S84, at a cumulative distribution function, the cumulative distribution function bin at which the sub_pointer is pointing is checked to determine if that bin contains at least one data value element. Each cumulative distribution function bin must have at least one element to enable arithmetic encoding in the conventional manner. If the cumulative distribution function does not have more than one element, then the addition pointer is updated, at step S88, to equal the new element value.

In a next step, the histogram is updated, at step S90, by adding one to all bins greater than or equal to the bin number at which the addition pointer is currently pointing, and subtracting one from all bins greater than or equal to the bin number at which the subtraction pointer is currently pointing. With this update, it is then determined, at step S92, if the subtraction count, sub_count, equals the subtraction maximum, sub_max. If not, the subtraction count is incremented, at step S94, and the cumulative distribution function awaits, at step S82, the next data element.

If the subtraction count does equal the subtraction maximum, then, at step S96, the subtraction pointer is incremented, indicating that it will be pointing at the next bin; the subtraction maximum is reset as now being equal to the current cumulative distribution function of the current bin; and the subtraction count is to 1. With this update complete, the system then awaits, at step S82, the next data element. This completes one cycle of a technique where the number of cumulative distribution function data value items remains constant.

The relatively small histograms that result from the image data channel splitting technique of the present invention synergistically work with this histogram update technique. As a result of the relatively small histogram size, the subtraction pointer can cycle through the entire histogram relatively quickly, whereby the cumulative distribution function data statistics are preserved from becoming stale, while at the same time providing data of a sufficient quantity to yield good results. The channel splitting technique is therefore found to actually enable better performance while at the same time reducing hardware requirements for the system. This is contrary to conventional wisdom, in which it is often suggested to increase channel size to, e.g., 16 or 24 bits, in an effort to improve performance. In accordance with the present invention, the exact opposite; i.e., shrinking of data channel extent; is found to produce improved results.

This splitting of the data into channels and while still yielding a good compression ratio is specifically achievable through the use of arithmetic encoding. Other compression techniques, such as Huffman encoding, that require each element be encoded with an integer number of bits, and as a result, highly skewed statistics cannot get as close to the entropy of the data set as can arithmetic encoding. Consider, e.g., the image data MSBs as an example. In an image that has been processed by Bayer Differencing, the MSBs primarily tend toward zero. While the Huffman encoding technique must assign this zero value at least a 1-bit code, the arithmetic encoding technique can assign as small a number of bits as necessary to match the informational value.

The arithmetic encoding technique for compressing the channels of image data can take any suitable implementation, including a multiplication-free technique. Instead of a conventional signal add-shift step, which is really a 2-bit multiply operation, a 3-bit multiply operation can be more preferably employed; it is found that performance going from 3 to 2 bits is noticeable as a few percentage points but going from 3 bits to full precision is not noticeable in performance.

It is therefore found that the extra hardware required for the additional add-shift operation is offset by the corresponding resulting compression improvement. In one preferable implementation, a guard register of eight bits can be used to reduce the carry-over effect, and bit stuffing can be employed when the carry-over register happens to fill with eight or more successive 1's. The encoding operation can be divided into parallel operations to enable further enhanced channel splitting; here it must be recognized that there exists a tradeoff between the resulting enhanced efficiency and a requirement that the arithmetic encoder, containing a relatively complex signal path with a multiplication and complex decision tree, would need to be replicated.

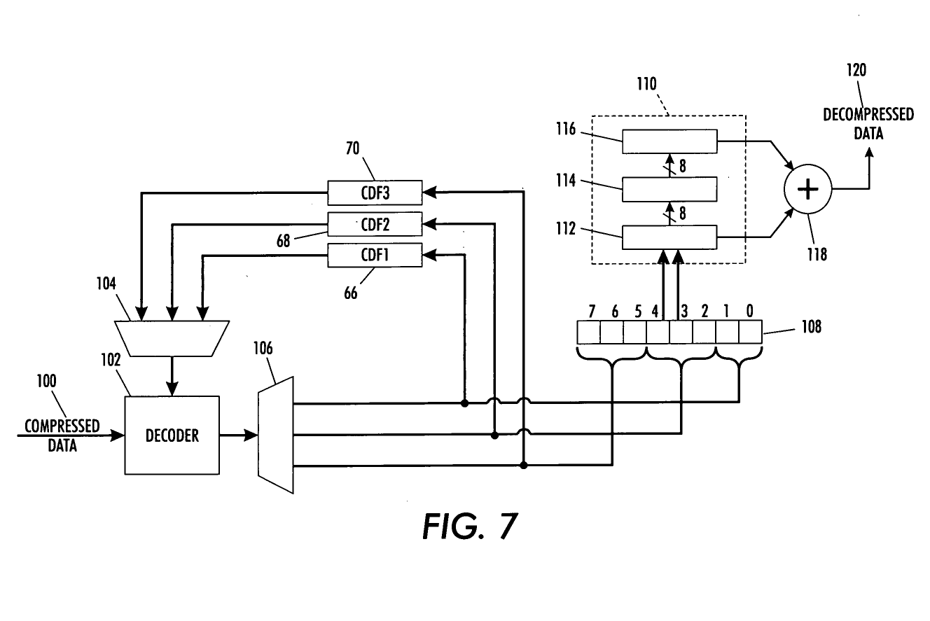

FIG. 7 is a diagram of the decompression operation corresponding to the compression operation above. This decompression can be carried out at any suitable stage of the image data processing; e.g., upon download to a computer or network for further processing and/or storage of the image data. In the decompression operation, compressed data 100 is sent to a decoder 102 for decoding the compressed data. The decoder synchronizes its decompression with multiplexer 104, which multiplexes data from the three histograms, CDF1 66, CDF2 68, and CDF3 70, such that the decoded data correctly corresponds with the original uncompressed data.

The resulting data is fed to de-multiplexer 106 into the corresponding number of split channels that were imposed prior to the image data compression, and then a full 8-bit wide data word is reconstructed by register 108 with the split channel data. Such reconstructed image data words are then directed to a two-stage pipeline that can accommodate three data words 112, 114, and 116. Alternating data words are then added together by an adder 118 to compensate for the prior Bayer Differencing operation. With this addition complete, the decompressed data 120 is fully reconstructed, and can be directed as desired to further processing and/or storage operations.

It is noted that the various processes described above may be carried out in hardware, firmware, or software without departing from the scope and concepts of the present invention.

While various examples and embodiments of the present invention have been shown and described, it will be appreciated by those skilled in the art that the spirit and scope of the present invention are not limited to the specific description and drawings herein, but extend to various modifications and changes.

What is claimed is:

1. A method for in-stream compression of bytes of digital image sensor data, comprising:
(a) capturing a scene and converting the captured scene into bytes of digital image sensor data;
(b) compressing the bytes of digital image sensor data;
(c) storing the compressed bytes of digital image sensor data in a temporary memory; and
(d) transferring the bytes of digital image sensor data from the temporary memory to a permanent memory.

2. The method as claimed in claim 1, wherein the bytes of digital image sensor data transferred from the temporary memory to a permanent memory is compressed bytes of digital image sensor data.

3. The method as claimed in claim 1, wherein the compressed bytes of digital image sensor data are decompressed before being transferred from the temporary memory to a permanent memory.

4. The method as claimed in claim 1, wherein the temporary memory is a static random access memory.

5. The method as claimed in claim 1, wherein the permanent memory is FLASH memory.

6. The method as claimed in claim 1, wherein the compression of the bytes of digital image sensor data comprises:
(b1) masking a specified number of least significant bits of a byte of digital image sensor data; and
(b2) encoding the masked bytes of digital image sensor data to generate compressed bytes of digital image sensor data.

7. The method as claimed in claim 1, wherein the compression of the bytes of digital image sensor data comprises:
(b1) subtracting alternate bytes of digital image sensor data to produce an entropy-reduced data model; and
(b2) encoding the difference bytes of digital image sensor data to generate compressed bytes of digital image sensor data.

8. The method as claimed in claim 1, wherein the compression of the bytes of digital image sensor data comprises:
(b1) masking a specified number of least significant bits of a byte of digital image sensor data;
(b2) subtracting alternate bytes of digital image sensor data to produce an entropy-reduced data model; and
(b3) encoding the difference bytes of digital image sensor data to generate compressed bytes of digital image sensor data.

9. The method as claimed in claim 1, wherein the compression of the bytes of digital image sensor data comprises:
(b1) splitting a byte of digital image sensor data into a predetermined number of channels, each channel having a bit width such that the sum of the bit widths of each channel equals a bit width of the byte of digital image sensor data;
(b2) operating upon each channel of digital image sensor data with distinct cumulative distribution functions;
(b3) multiplexing the distributed digital image sensor data; and
(b4) encoding the multiplexed digital image sensor data using arithmetic compression encoding.

10. The method as claimed in claim 1, wherein the compression of the bytes of digital image sensor data comprises:
(b1) masking a specified number of least significant bits of a byte of digital image sensor data;
(b2) splitting the masked byte of digital image sensor data into a predetermined number of channels, each channel having a bit width such that the sum of the bit widths of each channel equals a bit width of the byte of digital image sensor data;
(b3) operating upon each channel of digital image sensor data with a distinct cumulative distribution function;
(b4) multiplexing the distributed digital image sensor data; and
(b5) encoding the multiplexed digital image sensor data using arithmetic compression encoding.

11. The method as claimed in claim 1, wherein the compression of the bytes of digital image sensor data comprises:
(b1) subtracting alternate bytes of digital image sensor data to produce an entropy-reduced data model;
(b2) splitting the difference byte of digital image sensor data into a predetermined number of channels, each channel having a bit width such that the sum of the bit widths of each channel equals a bit width of the byte of digital image sensor data;
(b3) operating upon each channel of digital image sensor data with a distinct cumulative distribution function;
(b4) multiplexing the distributed digital image sensor data; and
(b5) encoding the multiplexed digital image sensor data using arithmetic compression encoding.

12. The method as claimed in claim 1, wherein the compression of the bytes of digital image sensor data comprises:
(b1) masking a specified number of least significant bits of a byte of digital image sensor data;
(b2) subtracting alternate bytes of digital image sensor data to produce an entropy-reduced data model;
(b3) splitting the difference byte of digital image sensor data into a predetermined number of channels, each channel having a bit width such that the sum of the bit widths of each channel equals a bit width of the byte of digital image sensor data;
(b4) operating upon each channel of digital image sensor data with a distinct cumulative distribution function;
(b5) multiplexing the distributed digital image sensor data; and
(b6) encoding the multiplexed digital image sensor data using arithmetic compression encoding.

13. A method of modeling, in stream, bytes of digital image sensor data for compression, comprising:
(a) masking a specified number of least significant bits of a byte of digital image sensor data; and
(b) subtracting alternate bytes of digital image sensor data to produce an entropy-reduced data model.

14. A method of encoding, in stream, bytes of digital image sensor data for compression, comprising:
(a) splitting a byte of digital image sensor data into a predetermined number of channels, each channel having a bit width such that the sum of the bit widths of each channel equals a bit width of the byte of digital image sensor data;
(b) operating upon each channel of digital image sensor data with a distinct cumulative distribution function;
(c) multiplexing the distributed digital image sensor data; and
(d) encoding the multiplexed digital image sensor data using arithmetic compression encoding.

15. A method of in-stream compression of bytes of digital image sensor data, comprising:
(a) masking a specified number of least significant bits of a byte of digital image sensor data;
(b) subtracting alternate bytes of digital image sensor data to produce an entropy-reduced data model;
(c) splitting a difference byte of digital image sensor data into a predetermined number of channels, each channel having a bit width such that the sum of the bit widths of each channel equals a bit width of the byte of digital image sensor data;
(d) operating upon each channel of digital image sensor data with a distinct cumulative distribution function;
(e) multiplexing the distributed digital image sensor data; and
(f) encoding the multiplexed digital image sensor data using arithmetic compression encoding.

16. A method of division free arithmetic encoding, comprising:
(a) fixing a number of elements in a histogram to a number that is a power of 2;
(b) determining a number of elements in a bin of a histogram; and
(c) performing a bit shifting operation upon the determined number of elements in a bin of a histogram to find a probability of symbol to be encoded.

17. The method as claimed in claim 16, wherein the number of elements in a histogram is fixed by adaptively removing elements from the histogram as new elements arrive.

18. The method as claimed in claim 16, wherein the number of elements in a histogram is fixed by removing elements from the histogram as new elements arrive in a weighted round-robin fashion.

19. The method as claimed in claim 17, wherein the removal elements from the histogram as new elements arrive is realized by tracking an order in which elements are added and removing the elements in the tracked order.

20. The method as claimed in claim 19, wherein the tracking of the order in which elements are added and removed is realized by incrementing a number of a bin to which an addition pointer is pointing when a new data element has been produced to be added to the histogram and decrementing a value of a to which a subtraction pointer is pointing when a new data element has been produced to be added to the histogram.

21. A method for adaptively fixing a number of elements in a histogram, comprising:
(a) producing a new data element to be added to the histogram;
(b) adding the new data element to the histogram;
(c) tracking an order in which new data elements are added; and
(d) removing a data element from the histogram in accordance with the tracked order.

22. The method as claimed in claim 21, wherein the tracking of the order in which elements are added and removed is realized by incrementing a number of a bin to which an addition pointer is pointing when a new data element has been produced to be added to the histogram and decrementing a value of a to which a subtraction pointer is pointing when a new data element has been produced to be added to the histogram.

23. A method for adaptively fixing a number of elements in a histogram, comprising:
(a) producing a new data element to be added to the histogram;
(b) adding the new data element to the histogram;
(c) incrementing a bin value, the bin value being number of elements in a bin, when a new data element is added to the histogram;
(d) determining if elements are to be removed from a present bin in the histogram;
(e) decreasing a value representing a number of elements to be removed from the present bin in the histogram when it is determined that elements are to be removed from the present bin in the histogram; and
(f) removing an element from the histogram when the value representing a number of elements to be removed is decreased.

24. The method as claimed in claim 23, further comprising:
(g) advancing to a next bin from which elements are to be removed when it is determined that elements are not to be removed from the present bin in the histogram;
(h) resetting the value representing a number of elements to be removed from the present bin in the histogram to a predetermined value.

25. The method as claimed in claim 24, wherein the predetermined value is equal to the value representing a number of elements to be removed from the present bin in the histogram divided by four.

26. The method as claimed in claim 23, wherein the element from the histogram is not removed if the value representing a number of elements to be removed from the present bin in the histogram is equal to one.
